(19) United States
(12) Patent Application Publication
(10) Pub. No.: US 2008/0258629 A1
(43) Pub. Date: Oct. 23, 2008

(54) APPARATUS AND METHOD FOR EXTRACTING POWER FROM AND CONTROLLING TEMPERATURE OF A FLUORESCENT LAMP

(75) Inventors: Yukio AKASHI, Clifton Park, NY (US); Terence R. KLEIN, Averill Park, NY (US)

Correspondence Address: HESLIN ROTHENBERG FARLEY & MESITI PC, 5 COLUMBIA CIRCLE, ALBANY, NY, 12203, US

(73) Assignee: RENSSELAER POLYTECHNIC INSTITUTE, Troy, NY (US)

(21) Appl. No.: 11/737,851

(22) Filed: Apr. 20, 2007

(51) Int. Cl. H01J 7/24

(52) U.S. Cl. 315/112

(57) ABSTRACT

An apparatus and method are provided for extracting power from and controlling temperature of a fluorescent lamp. The apparatus includes a magnetic structure having a magnetic core and a power extraction winding disposed at least partially around the magnetic core. The magnetic core is sized and configured to surround at least a portion of the fluorescent lamp having plasma current passing therethrough when the fluorescent lamp is powered ON. When the fluorescent lamp is powered ON, with the magnetic core surrounding the portion of the fluorescent lamp, plasma current of the fluorescent lamp forms a primary winding of a transformer defined by the magnetic structure and plasma current of the fluorescent lamp passing therethrough. Power is magnetically coupled via the transformer from the plasma current of the fluorescent lamp to the power extraction winding of the magnetic structure for use in powering a device to be coupled thereto.

### TECHNICAL FIELD

This invention relates in general to fluorescent lamps, and more particularly, to an apparatus, lamp assembly and method for facilitating power extraction from a fluorescent lamp, independent of or in combination with controlling and modulating the temperature of a portion of the fluorescent lamp to maintain efficiency thereof.

### BACKGROUND OF THE INVENTION

Fluorescent lamps are sensitive to ambient temperature. Depending on lamp type, the optimal ambient temperature at which light output of different lamp types is maximized varies. For example, T8 fluorescent lamps are optimized at a temperature of 25° C., while T5 fluorescent lamps have an optimal ambient temperature of 35° C. If the ambient temperature is higher or lower than these optimal temperatures, the light output and efficacy of the lamps are significantly reduced. FIG. 1 shows that a T5 fluorescent lamp is particularly sensitive to colder ambient conditions, losing 30% or more of its light output with a decrease of only 15° C. from its optimum ambient temperature. At still lower temperatures, the degradation of light output is even larger.

Thus, to maintain optimal light output and efficacy of a fluorescent lamp, it is advantageous to maintain ambient temperature at its optimum. However, it is difficult to maintain the ambient temperature surrounding a fluorescent lamp at a given temperature since such ambient temperature controls usually require more electric energy than needed to power the lamp itself.

A fluorescent lamp contains a larger quantity of liquid mercury than will become vaporized during operation. This excess liquid mercury condenses at the coldest point, or so-called “cold spot” of the lamp. This condensation of liquid mercury is the primary cause of light output efficacy degradation under colder than optimal operating conditions. However, by directly controlling the lamp's cold spot temperature, it is possible to control the quantity of vaporized mercury, thereby controlling the light output and lamp efficacy. While the cold spot temperature is optimum, the light output is maintained at its peak, regardless of ambient temperature. Location of the cold spot varies with lamp type. For example, the cold spot of a T8 fluorescent lamp is located near the center of the lamp bulb, while the cold spot of a T2 or T5 fluorescent lamp is located at the end cap of the lamp bulb.

Although numerous attempts have been made in the art to control the cold spot temperature of a fluorescent lamp, and thereby enhance efficiency of the fluorescent lamp, existing control mechanisms typically require redesign of the fluorescent lamp itself, or may only be applied to fluorescent lamp facilities wherein the ambient temperature is within a relatively narrow range. Therefore, alternative solutions are still needed to maintain a lamp's optimal cold spot temperature, particularly for certain facilities such as outdoor facilities, refrigerated and/or unconditioned warehouses. Additionally, a more efficient mechanism for powering a temperature regulation device is deemed advantageous, particularly when retrofitting a temperature control mechanism into an installed fluorescent lamp assembly.

### SUMMARY OF THE INVENTION

The shortcomings of the prior art are overcome and additional advantages are provided through the provision, in one embodiment, of an apparatus which includes a magnetic structure comprising a magnetic core and a power extraction winding disposed at least partially around the magnetic core. The magnetic core is sized and configured to surround at least a portion of a fluorescent lamp having plasma current passing therethrough when the fluorescent lamp is powered ON. When the fluorescent lamp is powered ON, with the magnetic core surrounding at least the portion of the fluorescent lamp, plasma current of the fluorescent lamp forms a primary winding of a transformer defined by the magnetic structure and plasma current of the fluorescent lamp passing therethrough, and power is magnetically coupled from the plasma current of the fluorescent lamp to the power extraction winding of the magnetic structure, e.g., for use in powering a device to be coupled thereto.

In another aspect, a lamp assembly is provided which includes a fluorescent lamp and a magnetic structure. The magnetic structure surrounds a portion of the fluorescent lamp, and includes a magnetic core and a power extraction winding disposed at least partially around the magnetic core. The magnetic core surrounds at least a portion of the fluorescent lamp having plasma current passing therethrough when the fluorescent lamp is powered ON. When the fluorescent lamp is powered ON, plasma current of the fluorescent lamp forms a primary winding of a transformer defined by the magnetic structure and plasma current of the fluorescent lamp passing therethrough, and power is magnetically coupled from the plasma current of the fluorescent lamp to the power extraction winding of the magnetic structure for use in powering a device when coupled thereto.

In a further aspect, a method is provided which includes: providing a magnetic structure including a magnetic core and a power extraction winding disposed at least partially around the magnetic core, the magnetic core being sized and configured to surround at least a portion of a fluorescent lamp having plasma current passing therethrough when the fluorescent lamp is powered ON; disposing the magnetic core at least around the portion of the fluorescent lamp; and wherein when the fluorescent lamp is powered ON, plasma current of the fluorescent lamp forms a primary winding of a transformer defined by the magnetic structure and plasma current of the fluorescent lamp passing therethrough, and power is magnetically coupled from the plasma current of the fluorescent lamp to the power extraction winding of the magnetic structure for use in powering a device when coupled thereto.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a graph of relative light output as a function of ambient temperature for T5 and T8 fluorescent lamps;

FIG. 2 is a schematic representation of one embodiment of a fluorescent lamp assembly and a power extraction and temperature modulation apparatus, in accordance with an aspect of the present invention;

FIG. 3 is a schematic representation of an alternate embodiment of a fluorescent lamp assembly and power extraction and temperature modulation apparatus, in accordance with an aspect of the present invention;

FIG. 4 is an isometric view of one implementation of the power extraction and temperature modulation apparatus of FIG. 3, in accordance with an aspect of the present invention;

FIG. 5 is an isometric view of one embodiment of the power extraction and temperature modulation apparatus of FIG. 4, shown disposed in position around at least a portion of a cold spot of a fluorescent lamp, such as a T5 fluorescent lamp, in accordance with an aspect of the present invention;

FIG. 6 is a schematic representation of another embodiment of a fluorescent lamp assembly and power extraction and temperature modulation apparatus, in accordance with an aspect of the present invention; and

FIG. 7 is a schematic representation of still another embodiment of a fluorescent lamp assembly and power extraction and temperature modulation apparatus, in accordance with an aspect of the present invention.

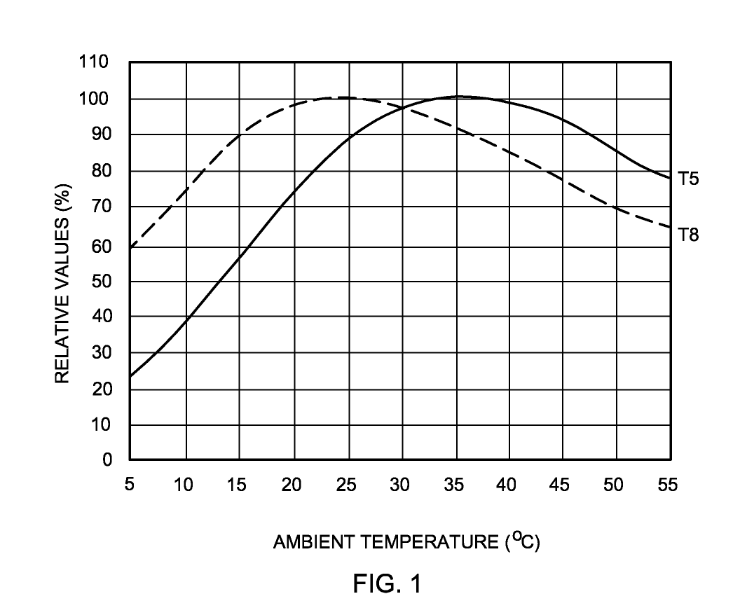

### DETAILED DESCRIPTION OF THE INVENTION

Generally stated, provided herein are an apparatus and method for extracting power from a fluorescent lamp, for example, for controlling temperature of a portion of the fluorescent lamp to maintain efficiency thereof. The apparatus includes a magnetic structure having a magnetic core and a power extraction winding disposed at least partially around the magnetic core. The magnetic core is sized and configured to surround at least a portion of the fluorescent lamp having plasma current passing therethrough (i.e., when the fluorescent lamp is powered ON). When the fluorescent lamp is powered ON, with the magnetic core surrounding at least the portion thereof, plasma current of the fluorescent lamp forms a primary winding of a transformer defined by the magnetic structure and plasma current of the fluorescent lamp passing therethrough, and power is magnetically coupled from the plasma current to the power extraction winding of the magnetic structure for powering a device electrically coupled thereto. In one embodiment, the device is a temperature modulation component which varies temperature of at least a portion of the fluorescent lamp, for example, to facilitate maintaining a cold spot temperature of the fluorescent lamp within a desired range of an optimum temperature.

In certain embodiments, the magnetic core is a ferromagnetic material with a composition chosen to have a Curie point which functions as a switch mechanism for discontinuing power extraction from the plasma current of the fluorescent lamp when the magnetic core surrounding the portion of the fluorescent lamp reaches its Curie point. In this embodiment, the temperature modulation component includes a resistive heating element which is disposed adjacent to the cold spot of the fluorescent lamp, for example, on an inner surface of the magnetic core, with the magnetic core at least partially encircling the cold spot of the fluorescent lamp. Although various aspects of the present invention are described herein below with reference to a T5 fluorescent lamp, the concepts presented are applicable to other sizes and types of fluorescent lamps. Advantageously, it is easier to control the cold spot temperature of certain fluorescent lamps, such as a T5 fluorescent lamp, due to the accessibility of the cold spot location (i.e., near one end thereof). Further, T5 fluorescent lamps are generally more sensitive to colder ambient temperatures since they are optimized at a higher temperature than other typical fluorescent lamps, and therefore experience a greater degradation of light output at colder temperatures.

Field demonstrations have indicated that the use of T5 fluorescent lamp technology in high ceiling applications can reduce energy use by 30% to 50% over a typical metal-halide lighting system. Fluorescent lamps have also been shown to be effective in outdoor applications, saving 30% over high-pressure sodium lamps in a streetlight application, due to their ability to provide lighting spectrally tuned to the human nighttime visual system. However, end users have been apprehensive about using T5 lamps in spaces such as unconditioned or refrigerated warehouses, colder areas of grocery stores or other buildings, or in outdoor applications because of the lamp's sensitivity to temperature. Thus, presented herein is a simple, inexpensive apparatus that can be easily installed on a fluorescent lamp (such as a T5 fluorescent lamp) to maintain its cold spot temperature, light output, and efficacy, making these lamps appropriate for use in a much wider range of applications than currently available, thus increasing their market penetration, and reducing lighting energy use dramatically.

The solution presented herein is a magnetic apparatus that couples to the plasma current of the fluorescent lamp, and employs a magnetic structure, which together with the plasma current, defines a transformer to extract power from this lamp current. As used herein, “plasma current” refers to the current passing through the plasma within an active fluorescent lamp, and “fluorescent lamp” refers to any fluorescent light, including fluorescent tubes such as T2, T5 and T8 fluorescent lamps.

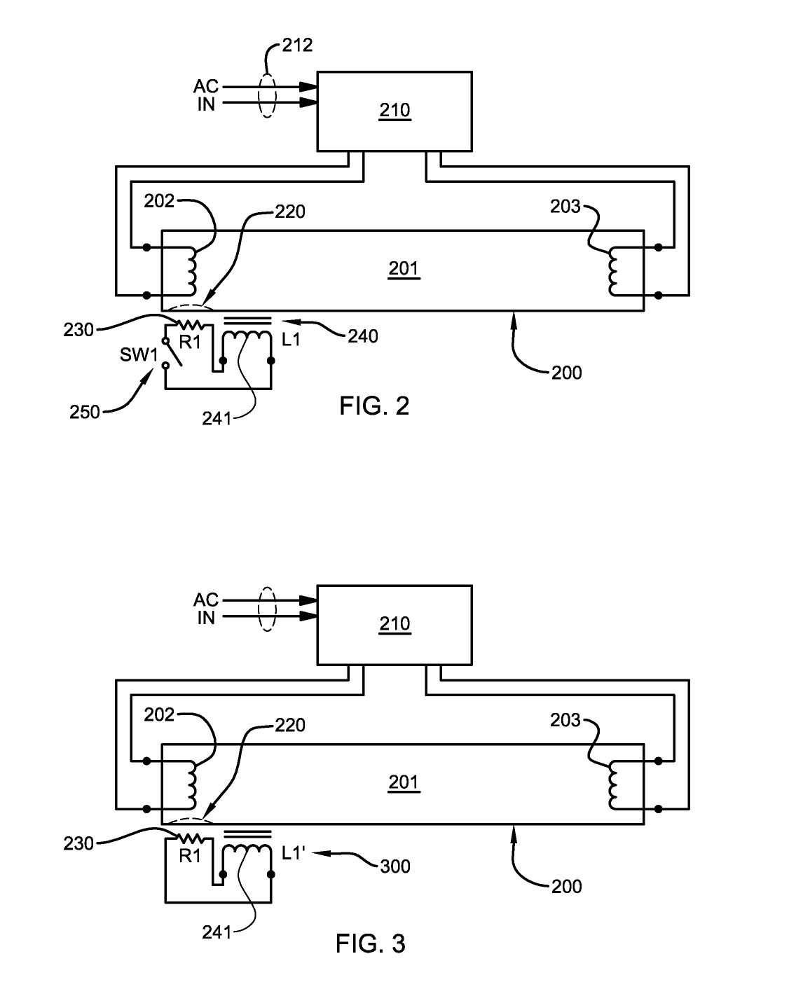

FIG. 2 depicts one embodiment of a fluorescent lamp assembly 200, such as a T5 lamp assembly, and a power extraction and temperature modulation apparatus, in accordance with an aspect of the present invention. Fluorescent lamp assembly 200 includes, in this embodiment, a fluorescent lamp 201, comprising sealed glass bulb which contains a small amount of mercury 220 and an inert gas, such as argon or neon gas. Fluorescent lamp 201 is a gas discharge lamp that uses electricity applied between two electrodes 202, 203 disposed at opposite ends of the lamp. When the lamp assembly is turned ON, electric power heats up one of the electrodes enough to emit electrons. These electrons collide with and ionize gas atoms in the lamp bulb surrounding the filament to form a plasma by a process of impact ionization. As a result of avalanche ionization, the conductivity of the ionized gas rapidly rises, allowing higher currents to flow through the lamp. These currents are known in the art as the “plasma current” of the fluorescent lamp.

The mercury 220, which exists at a stable vapor pressure equilibrium point of about 1 part per 1,000 inside of the fluorescent tube, is likewise ionized, causing it to emit light in the ultraviolet (UV) region of the spectrum predominantly at wavelengths of 253.7 nm and 185 nm. The efficiency of fluorescent lighting owes much to the fact that low pressure mercury discharges emit about 65% of their total light at the 254 nm line (and about 10%-20% of the light emitted in UV is at the 185 nm line). The UV light is absorbed by the bulb's fluorescent coating, which re-radiates the energy wavelengths: two intense lines of 440 nm and 546 nm wavelength appear on commercial fluorescent tubes to emit visible light. The blend of phosphors controls the color of the light, and along with bulb's glass, prevents the harmful UV light from escaping.

As is well known, a fluorescent lamp typically employs a ballast 210 which is powered by an alternating voltage 212. Ballast 210 regulates current flow through the fluorescent lamp, and depending on the lamp implementation, could be a resistive ballast, magnetic ballast or electronic ballast.

On a T5 fluorescent lamp, the cold spot (where the mercury 220 accumulates), is located at one end of the lamp, for example, at the metallic end cap about 2 mm from the glass envelope on the surface where the lamp label is printed. The cold spot temperature is usually optimally approximately 10° C. degrees higher than the optimal ambient temperature under a normal operation condition. To maintain optimal output of a T5 fluorescent lamp, therefore, it is advantageous to maintain the cold spot temperature at, for example, approximately 45° C., which is 10° C. higher than its optimal ambient temperature of 35° C.

As briefly noted above, presented herein is a relatively simple, inexpensive apparatus which can be employed to extract power from a fluorescent lamp, and modulate temperature of the fluorescent lamp, for example, to increase temperature at a cold spot of the fluorescent lamp.

In FIG. 2, power is extracted employing a magnetic structure L1 240 which is sized and configured to surround at least a portion of fluorescent lamp 201 having plasma current passing therethrough. In this embodiment, magnetic structure L1 240 is disposed at or adjacent to the cold spot of the lamp. When the fluorescent lamp is turned ON, plasma current of the fluorescent lamp forms a primary winding of a transformer defined by magnetic structure L1 240 and the plasma current, and power is magnetically coupled therefrom to a power extraction winding 241 of the transformer. In this embodiment, a temperature dependent switch mechanism SW1 250 is serially connected with a resistive heating element R1 230 across the power extraction winding of the transformer. SW1 250 controls powering of the resistive heating element R1 230 by the transformer. As shown, the resistive heating element R1 230 is disposed adjacent to the cold spot of the fluorescent tube 201 (i.e., the spot containing mercury, in this example).

In operation, magnetic structure L1 240 of the power extraction apparatus magnetically couples to the fluorescent lamp's plasma current to extract power from the plasma current. In one embodiment, the magnetic core of the transformer is one of a ring-shaped structure or a cylindrical-shaped structure sized and configured to slip over and encircle a portion of the fluorescent lamp. When so positioned, the lamp's plasma current forms a one-turn primary winding for the transformer, and the power extraction winding encircling a portion of the magnetic core is a secondary winding of the transformer. Power extracted to the power extraction winding is used to drive, for example, a heating circuit such as switch mechanism SW1 250 and resistive heating element R1 230. In one embodiment, switch mechanism SW1 250 comprises a temperature sensor which closes to heat the cold spot of the fluorescent lamp when needed, and opens once the cold spot reaches or exceeds a preset temperature to remove power from the resistive heating element.

Those skilled in the art should note that the power extraction apparatus presented herein (e.g., comprising magnetic structure L1 240) could be employed to power a non-temperature-related device(s) as well (e.g., any low power electronic device). For example, the magnetic structure could be used to signal failure of the fluorescent lamp or fluorescent lamp luminaire, for example, through a failure to generate a signal indicative of the proper operation of the fluorescent lamp. These signals could be accumulated at a central location of a facility, and allow a failure message to be generated upon detection of the absence of a signal.

FIG. 3 depicts an alternate implementation of the apparatus presented herein. As shown, the fluorescent lamp assembly 200 again includes fluorescent lamp 201 having a cold spot where, for example, mercury 220 accumulates. In this embodiment, the magnetic structure L1′ 300 comprises a ferromagnetic core, such as a ferrite material, that has a composition chosen to have a Curie point which functions as the switch mechanism for the temperature modulation component, such as resistive heating element R1 230. Magnetic structure L1′ 300 again includes a power extraction winding 241 disposed at least partially around the magnetic core. The power extraction winding 241 is electrically coupled to the temperature modulation component which, in this embodiment, is disposed adjacent to the cold spot of fluorescent lamp 201.

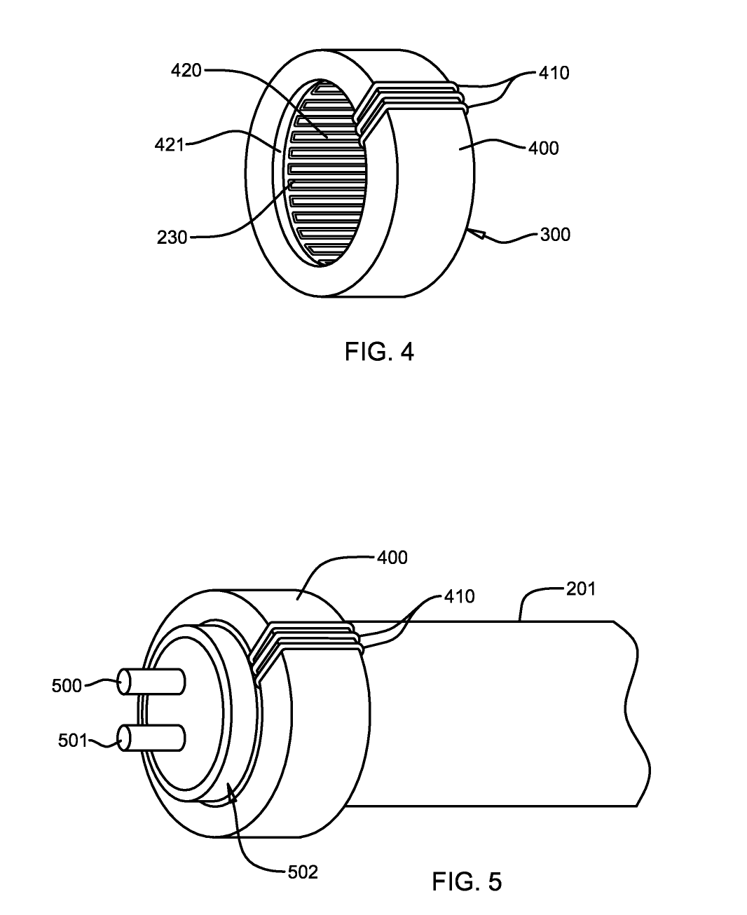

FIG. 4 is an isometric view of one embodiment of a power extraction and temperature modulation apparatus such as depicted in FIG. 3. In this embodiment, magnetic structure 300 includes a magnetic core 400 and a power extraction winding 410 disposed at least partially around the magnetic core. As shown, magnetic core 400 is (in one embodiment) a ring-shaped or cylindrical-shaped structure having a central opening 420 defined by an inner surface 421 of the magnetic core. Further, in this embodiment, resistive heating element 230 (which is electrically coupled to power extraction winding 410) is disposed at least partially along inner surface 421 of magnetic core 400. In an alternate embodiment, resistive heating element 230 is separate from, but electrically coupled to, the magnetic structure 300. As a further variation, composition of the ferromagnetic core could be modified to include a lossy magnetic material to dissipate heat when activated, thereby combining the resistive heating element with the magnetic core structure.

Advantageously, opening 420 of magnetic core 400 is sized and shaped for positioning of the apparatus of FIG. 4 over a plasma current carrying portion of fluorescent lamp 201, such as shown in FIG. 5. By appropriately sizing opening 420, no exterior fasteners are needed to position the apparatus of FIG. 4 over the fluorescent lamp, making retrofitting of the apparatus onto an installed fluorescent lamp simple. Further, the magnetic structure, including magnetic core 400, is sized to have a thickness, for example, 1-2 centimeters or less, to ensure that the apparatus can be readily retrofitted into any existing fluorescent lamp luminaire. The apparatus, comprising magnetic core 400 and power extraction winding 410 is positioned adjacent to one end of fluorescent lamp 201, and in this embodiment, at least partially overlaps the cold spot of the fluorescent lamp, for example, at or adjacent to ferrule 502. Although not shown, contact pins 500, 501 electrically couple to a fluorescent lamp fixture for powering one electrode of the lamp at the illustrated lamp end.

Operationally, plasma current established within the fluorescent lamp between electrodes 202, 203 (FIG. 3) forms a one turn primary that is magnetically coupled to the power extraction winding 410 (FIGS. 4 & 5). Power extraction winding 410 impresses a voltage across the temperature modulation component, which in this example, comprises resistive heating element 230 of FIG. 4, to produce a heat dissipation equal to the voltage squared, divided by the resistance. This heat dissipation is thermally coupled by conduction and/or convection to the fluorescent lamp's cold spot by positioning the resistive heating element adjacent to, and at least partially overlapping or surrounding the cold spot.

The device's switching mechanism opens when the cold spot, or more particularly in this embodiment, the magnetic core, has reached the predefined shut-off temperature (i.e., the selected Curie point). It is desirable not to continue heating the lamp after it has reached the desired cold spot operating temperature because excessive heating wastes power. The temperature-based switching mechanism stops the heating effect once the desired temperature is reached. In the embodiment of FIG. 2, the switching mechanism could be a bi-metal switch, a temperature-dependent resistor, or other temperature sensing device capable of turning off the heater when needed. Alternatively, in the embodiment of FIGS. 3-5, properties of the magnetic material itself, i.e., the Curie effect, may be employed as the temperature-dependent switch to deactivate, e.g., the heating of the cold spot. Advantageously, the switching mechanism re-closes if the lamp's cold spot becomes too cold.

Low Curie temperature ferromagnetic, and more particularly, ferrite materials, are known in the art. For example, reference an IEEE article entitled “The Characteristics of Ferrite Cores with Low Curie Temperature in their Application”, IEEE Transactions on Magnetics (June 1965), the entirety of which is hereby incorporated herein by reference. As is well known, the Curie point or temperature is a temperature above which a ferromagnetic substance looses its ferromagnetism and becomes paramagnetic. In typical transformer applications, the Curie point is as high as possible, to ensure continued operation of the transformer. However, in the FIGS. 3-5 embodiment of the apparatus described herein, the composition of the magnetic core is selected so that its Curie point is at a defined temperature or within a defined temperature range relative to the optimal cold spot temperature. In one implementation, the ferrite material is a Mn—Cu ferrite. As shown in the IEEE article, ferrite materials with a Curie temperature in the 30° C.-40° C. range are possible. Curie temperature can thus be selected within a range at or near the desired cold spot temperature for operation of a fluorescent lamp, such as a T5 fluorescent lamp.

An apparatus such as described above can be installed on or integrated with a fluorescent lamp in a number of ways. For example, as a ring-shaped structure or cylindrical-shaped structure, the apparatus could be separately fabricated from the fluorescent lamp, and retrofitted thereon by easily slipping around the lamp bulb in an existing lighting installation by a lamp installer, such as an end user or maintenance person. Advantageously, no wiring is required in the installation. Alternatively, the apparatus could be integrated as part of the luminaire structure, for example, as part of a lamp socket structure in a luminaire. The apparatus could be a ring or cylinder structure attached to a socket that the lamp tube is inserted through to reach the socket contacts. Luminaire manufacturers could apply such an apparatus to their luminaire products. Still further, the apparatus could be attached as a structure surrounding the metal sleeve (e.g., ferrule) at the end of a fluorescent lamp tube. Fluorescent lamp manufacturers could implement such a device on their lamp products. Still further, the apparatus could be integrated with the lamp (e.g., lamp bulb) itself. This would allow lamp manufacturers to develop fluorescent lamps appropriate for lower temperatures.

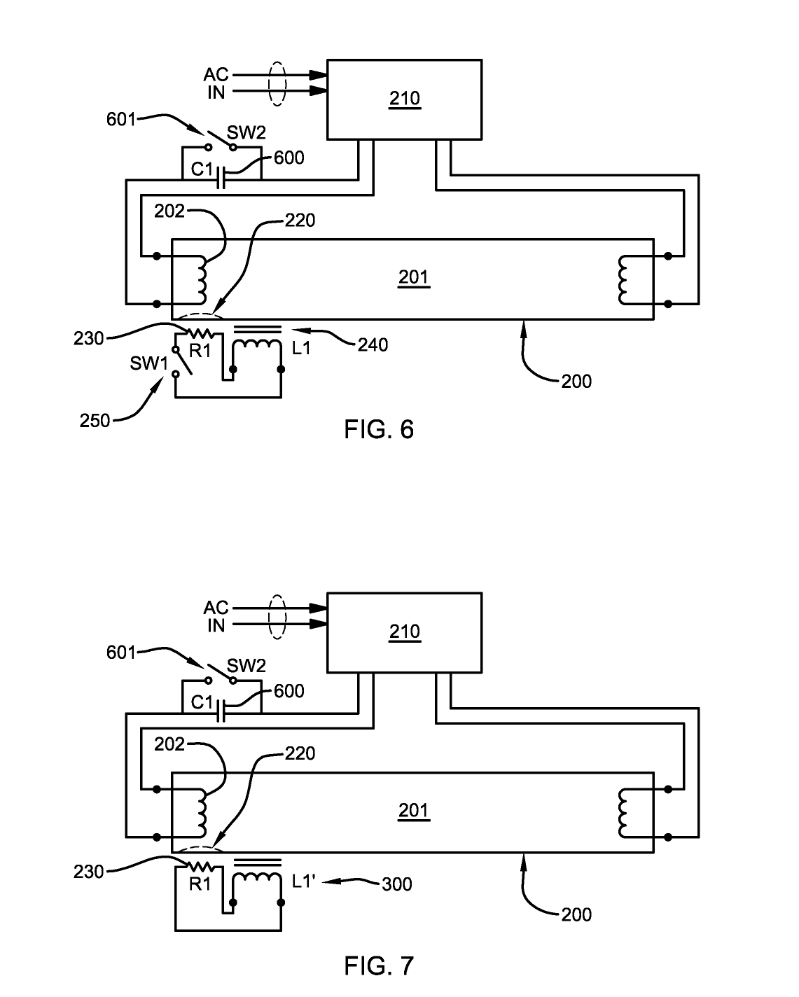

FIGS. 6 & 7 depict further embodiments of a power extraction and temperature modulation apparatus, in accordance with an aspect of the present invention.

The FIG. 6 implementation is identical to the implementation of FIG. 2, with the addition of a cooling mechanism for cooling the fluorescent lamp when the lamp tube is too hot at the cold spot. This is accomplished by switching in a reactive element C1 600 into the fluorescent lamp's current path between, for example, ballast 210 and electrode 202 of fluorescent lamp 201. A switch mechanism SW2 601 closes when the fluorescent lamp has cooled to the desired operating temperature set point, and reopens when the fluorescent lamp becomes too hot. In one implementation, switch mechanism SW2 601 comprises a temperature sensor which senses temperature at the cold spot of the fluorescent lamp. Alternative cooling approaches are also possible. For example, a fan mechanism could be selectively operated to cool the cold spot of the fluorescent lamp when temperature at the cold spot exceeds a desirable range. Together, the temperature modulation structures, including magnetic structure 240, resistive heating element R1 230, switch mechanism SW1, reactance C1 600 and switch mechanism SW2 601 cooperate to maintain the cold spot temperature at or within a defined range from the optimal temperature. Additionally, switch mechanism SW2 could also be powered by the magnetic structure 240, or more particularly, the power extraction winding thereof.

The implementation depicted in FIG. 7 is analogous to that of FIG. 3, with the difference being the addition of reactance C1 600 and switch mechanism SW2 601 into the current path in parallel between, for example, ballast 210 and electrode 202 of fluorescent lamp 201 of lamp assembly 200. In this implementation, the magnetic structure L1′ 300 again comprises a ferromagnetic material core that has a selected Curie point in a low temperature range that allows the transformer core to function as a temperature dependent switch mechanism, which allows (for example) selective powering of the resistive heating element R1 230 to heat the cold spot of the fluorescent lamp only when necessary.

To summarize, provided herein is an apparatus which includes a magnetic structure comprising a magnetic core and a power extraction winding disposed at least partially around the magnetic core. The magnetic core is sized and configured to surround at least a portion of the fluorescent lamp, for example, having plasma current passing therethrough when the fluorescent lamp is powered ON. When the fluorescent lamp is powered ON, with the magnetic core surrounding at least the portion of the fluorescent lamp, plasma current of the fluorescent lamp forms a primary winding of a transformer defined by the magnetic structure and plasma current of the fluorescent lamp passing therethrough. Power is magnetically coupled from the plasma current of the fluorescent lamp to the power extraction winding of the magnetic structure, for example, for use in powering a device to be coupled thereto.

In one implementation, the device is a temperature modulation component, such as a resistive heating element. Power magnetically coupled into the power extraction winding powers the temperature modulation component to vary temperature of at least a portion of the fluorescent lamp. A temperature dependent switch mechanism may also be provided for controlling powering of the temperature modulation component. In one implementation, the magnetic core includes a ferromagnetic material with a composition chosen to have a Curie point which functions as the temperature dependent switch mechanism for discontinuing temperature modulation of at least a portion of the fluorescent lamp by discontinuing power extraction from the plasma current of the fluorescent lamp when the magnetic core surrounding the portion of the fluorescent lamp reaches its Curie point.

In further aspects, the temperature modulation component is a resistive heating element configured for disposition adjacent to a cold spot of the fluorescent lamp when the apparatus is in use with the fluorescent lamp powered ON. The magnetic structure may include an inner surface defining an opening sized and configured to receive a portion of the fluorescent lamp therein. In this implementation, the resistive heating element may be disposed at least partially along the inner surface of the magnetic core, and when in use, the magnetic core surrounds at least a portion of the cold spot of the fluorescent lamp. In one implementation, the magnetic core is a ring-shaped structure or a cylindrical-shaped structure sized to encircle the fluorescent lamp. Although applicable to any fluorescent lamp, the concepts presented are particularly advantageous for one of a T5, T4, T3, T2 or T1 fluorescent lamp, with the cold spot disposed at one end of the fluorescent lamp.

The apparatus can be separately fabricated from the fluorescent lamp, or integrated with the fluorescent lamp or a fluorescent lamp luminaire, such as a socket thereof.

In another aspect, a method is provided which includes: providing a magnetic structure including a magnetic core and a power extraction winding disposed at least partially around the magnetic core, the magnetic core being sized and configured to surround at least a portion of a fluorescent lamp having plasma current passing therethrough when the fluorescent lamp is powered ON; disposing the magnetic core at least around the portion of the fluorescent lamp; and wherein when the fluorescent lamp is powered ON, plasma current of the fluorescent lamp forms a primary winding of a transformer defined by the magnetic structure and plasma current of the fluorescent lamp passing therethrough, and power is magnetically coupled from the plasma current of the fluorescent lamp to the power extraction winding of the magnetic structure for use in powering a device to be coupled thereto.

Advantageously, those skilled in the art will note from the above description that provided herein is an apparatus, lamp assembly and method that allow direct powering of a device, such as a temperature modulation component, employing at least in part plasma current of a powered fluorescent lamp. Advantageously, any powering required by the apparatus is small relative to the light output gained by the apparatus. As a further enhancement, the magnetic core of the apparatus is a ferromagnetic material chosen to have a Curie point which functions as a switching mechanism to discontinue powering of a temperature modulation component, such as a resistive heating element, at or near the optimum cold spot temperature of the fluorescent lamp. Additionally, the magnetic core can be used to generate a signal that the fluorescent lamp or ballast has failed, e.g., based on whether or not there is plasma current passing through the core. The apparatus presented can effectively facilitate maintaining a cold spot temperature, efficacy, and light output of a fluorescent lamp, such as a T5 fluorescent lamp, over a broader range of ambient temperature conditions than currently possible. The apparatus presented can be employed with any manufacturer's luminaire, and is applicable to a wide range of fluorescent lamp applications, including warehouses and other interior applications, as well as outdoor applications.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. An apparatus comprising:
a magnetic structure including a magnetic core and a power extraction winding disposed at least partially around the magnetic core, the magnetic core being sized and configured to surround at least a portion of a fluorescent lamp having plasma current passing therethrough when the fluorescent lamp is powered ON; and
wherein when the fluorescent lamp is powered ON, with the magnetic core surrounding at least the portion of the fluorescent lamp, plasma current of the fluorescent lamp forms a primary winding of a transformer defined by the magnetic structure and plasma current of the fluorescent light passing therethrough, and power is magnetically coupled from the plasma current of the fluorescent lamp to the power extraction winding of the magnetic structure for use in powering a device when coupled thereto.

2. The apparatus of claim 1, wherein the device is a temperature modulation component electrically coupled to the power extraction winding, and wherein power magnetically coupled into the power extraction winding powers the temperature modulation component to vary temperature of at least a portion of the fluorescent lamp.

3. The apparatus of claim 2, further comprising a temperature dependent switch mechanism for controlling powering of the temperature modulation component.

4. The apparatus of claim 3, wherein the magnetic core comprises a ferromagnetic material with a composition chosen to have a Curie point which functions as the temperature dependent switch mechanism for discontinuing temperature modulation of at least a portion of the fluorescent lamp by discontinuing power extraction from the plasma current of the fluorescent lamp when the magnetic core surrounding the portion of the fluorescent lamp reaches its Curie point.

5. The apparatus of claim 2, wherein the temperature modulation component comprises a resistive heating element, and wherein the resistive heating element is configured for disposition adjacent to a cold spot of the fluorescent lamp when the apparatus is in use with the fluorescent lamp powered ON.

6. The apparatus of claim 5, wherein the magnetic core comprises an inner surface defining an opening sized and configured to receive the portion of the fluorescent lamp therein, and wherein the resistive heating element is disposed at least partially along the inner surface of the magnetic core, and when in use, the magnetic core surrounds at least a portion of the cold spot of the fluorescent lamp.

7. The apparatus of claim 5, wherein the magnetic core comprises a ferromagnetic material with a composition chosen to have a Curie point which functions as a switch mechanism to automatically discontinue heating of the cold spot of the fluorescent lamp by discontinuing power extraction from the plasma current of the fluorescent lamp when the ferromagnetic material surrounding the portion of the fluorescent lamp reaches its Curie point.

8. The apparatus of claim 7, wherein the fluorescent lamp comprises a fluorescent tube, and is one of a T12, T8, T5, T4, T3, T2 or T1 fluorescent lamp, and wherein the cold spot is disposed at one end thereof when the fluorescent lamp is powered ON.

9. The apparatus of claim 1, wherein the fluorescent lamp comprises a light emitting bulb, and wherein the magnetic core is configured for retrofitting onto the light emitting bulb of the fluorescent lamp and comprises one of a ring-shaped structure or a cylindrical-shaped structure having an opening sized and configured to receive a portion of the light emitting bulb of the fluorescent lamp therein.

10. The apparatus of claim 1, further comprising a temperature dependent switch mechanism to control power extraction from the plasma current of the fluorescent lamp.

11. The apparatus of claim 10, wherein the magnetic core comprises a ferromagnetic material with a composition chosen to have a Curie point which functions as the temperature dependent switch mechanism for automatically discontinuing power extraction from the plasma current of the fluorescent lamp upon the magnetic core surrounding the portion of the fluorescent lamp reaching its Curie point.

12. A lamp assembly comprising:
a fluorescent lamp;
a magnetic structure surrounding a portion of the fluorescent lamp, the magnetic structure including a magnetic core and a power extraction winding disposed at least partially around the magnetic core, the magnetic core surrounding at least a portion of the fluorescent lamp having plasma current passing therethrough when the fluorescent lamp is powered ON; and
wherein when the fluorescent lamp is powered ON, plasma current of the fluorescent lamp forms a primary winding of a transformer defined by the magnetic structure and plasma current of the fluorescent lamp passing therethrough, and power is magnetically coupled from the plasma current of the fluorescent lamp to the power extraction winding of the magnetic structure for use in powering a device when coupled thereto.

13. The lamp assembly of claim 12, wherein the magnetic structure is one of a discrete component from the fluorescent lamp or integrated with the fluorescent lamp.

14. The lamp assembly of claim 13, further comprising a fluorescent lamp luminaire, and wherein the fluorescent lamp is electrically coupled to the fluorescent lamp luminaire when powered ON.

15. The lamp assembly of claim 12, wherein the device is a temperature modulation component electrically coupled to the power extraction winding, and wherein power magnetically coupled into the power extraction winding powers the temperature modulation component to vary temperature of at least a portion of the fluorescent lamp.

16. The lamp assembly of claim 15, further comprising a temperature dependent switch mechanism for controlling powering of the temperature modulation component, and wherein the magnetic core comprises a ferromagnetic material with a composition chosen to have a Curie point which functions as the switch mechanism for discontinuing temperature modulation of at least a portion of the fluorescent lamp by discontinuing power extraction from the plasma current of the fluorescent lamp when the magnetic core surrounding the portion of the fluorescent lamp reaches its Curie point.

17. The lamp assembly of claim 15, wherein the temperature modulation component is a heating element, and wherein the heating element comprises one of a discrete resistive heating element, or a lossy magnetic material within the magnetic core, and wherein the temperature modulation component is configured for disposition adjacent to a cold spot of the fluorescent lamp when in use.

18. The lamp assembly of claim 17, wherein the magnetic core comprises an inner surface defining an opening sized and configured to receive the portion of the fluorescent lamp therein, and wherein the temperature modulation component comprises the discrete resistive heating element, which is disposed at least partially along the inner surface of the magnetic core, and when in use, the magnetic core surrounds at least a portion of the cold spot of the fluorescent lamp.

19. The lamp assembly of claim 17, wherein the magnetic core comprises a ferromagnetic material with a composition chosen to have a Curie point which functions as a temperature dependent switch mechanism to automatically discontinue heating of the cold spot of the fluorescent lamp by discontinuing power extraction from the plasma current of the fluorescent lamp when the ferromagnetic material surrounding the portion of the fluorescent lamp reaches its Curie point.

20. The lamp assembly of claim 12, wherein the fluorescent lamp comprises a fluorescent tube, and is one of a T12, T8, T5, T4, T3, T2 or T1 fluorescent lamp, and wherein the cold spot is disposed at one end thereof when the fluorescent lamp is powered ON.

21. The lamp assembly of claim 12, wherein the fluorescent lamp comprises a light emitting bulb, and wherein the magnetic core is configured for retrofitting onto the light emitting bulb of the fluorescent lamp and comprises one of a ring-shaped structure or a cylindrical-shaped structure having an opening sized and configured to receive a portion of the light emitting bulb of the fluorescent lamp therein.

22. The lamp assembly of claim 12, further comprising a temperature dependent switch mechanism to control power extraction from the plasma current of the fluorescent lamp, and wherein the magnetic core comprises a ferromagnetic material with a composition chosen to have a Curie point which functions as the temperature dependent switch mechanism for automatically discontinuing power extraction from the plasma current of the fluorescent lamp upon the magnetic core surrounding the portion of the fluorescent lamp reaching its Curie point.

23. A method comprising:
providing a magnetic structure including a magnetic core and a power extraction winding disposed at least partially around the magnetic core, the magnetic core being sized and configured to surround at least a portion of a fluorescent lamp having plasma current passing therethrough when the fluorescent lamp is powered ON;
disposing the magnetic core at least around the portion of the fluorescent lamp; and
wherein when the fluorescent lamp is powered ON, plasma current of the fluorescent lamp forms a primary winding of a transformer defined by the magnetic structure and plasma current of the fluorescent lamp passing therethrough, and power is magnetically coupled from the plasma current of the fluorescent lamp to the power extraction winding of the magnetic structure for use in powering a device when coupled thereto.

24. The method of claim 23, further comprising electrically coupling the device to the power extraction winding of the magnetic structure, the device being a temperature modulation component, and wherein the method further comprises disposing the temperature modulation component adjacent to the fluorescent lamp to facilitate varying temperature of at least a portion of the fluorescent lamp.

25. The method of claim 24, further comprising providing a temperature dependent switch mechanism for controlling powering of the temperature modulation component, wherein providing the temperature dependent switch mechanism comprises choosing a ferromagnetic material composition for the magnetic core having a Curie point which functions as the temperature dependent switch mechanism for discontinuing temperature modulation of at least a portion of the fluorescent lamp by discontinuing power extraction from the plasma current of the fluorescent lamp when the magnetic core surrounding at least the portion of the fluorescent lamp reaches its Curie point.

26. The method of claim 23, wherein the fluorescent lamp comprises a fluorescent tube having a cold spot disposed at one end thereof when the fluorescent lamp is powered ON, and wherein disposing the magnetic core around the portion of the fluorescent lamp further comprises positioning the magnetic core at the one end of the fluorescent tube having the cold spot.

27. The method of claim 23, wherein the fluorescent lamp comprises a light emitting bulb, and wherein the magnetic core is configured for retrofitting onto the light emitting bulb of the fluorescent lamp and comprises one of a ring-shaped structure or a cylindrical-shaped structure having an opening sized and configured to receive a portion of the light emitting bulb of the fluorescent lamp therein.

28. The method of claim 23, further comprising providing a fluorescent lamp luminaire, and integrating the magnetic structure as a portion of the fluorescent lamp luminaire, and wherein disposing the magnetic core at least around a portion of the fluorescent lamp comprises inserting the fluorescent lamp into the fluorescent lamp luminaire, with the magnetic core at least around the portion of the fluorescent lamp.

29. The method of claim 23, wherein the magnetic structure is attached to the fluorescent lamp at one end so as to at least partially surround a metal sleeve at the one end of the fluorescent lamp.

30. The method of claim 23, wherein the fluorescent lamp comprises a fluorescent lamp bulb, and the disposing comprises integrating the magnetic structure with the fluorescent lamp bulb.
